(19) United States
(12) Patent Application Publication
(10) Pub. No.: US 2019/0193714 A1
(43) Pub. Date: Jun. 27, 2019

(54) APPARATUS AND METHOD FOR CONTROLLING MILD HYBRID ELECTRIC VEHICLE

(71) Applicants: Hyundai Motor Company, Seoul (KR); Kia Motors Corporation, Seoul (KR)

(72) Inventor: YoungMin KIM, Yongin-Si (KR)

(73) Assignees: Hyundai Motor Company, Seoul (KR); Kia Motors Corporation, Seoul (KR)

(21) Appl. No.: 16/128,714

(22) Filed: Sep. 12, 2018

(30) Foreign Application Priority Data
Dec. 21, 2017 (KR) 10-2017-0177244

(51) Int. Cl. B60W 20/12; B60K 6/26

(52) U.S. Cl. CPC B60W 20/12; B60K 6/26; B60K 2006/268; B60Y 2200/92; B60W 2550/20; B60W 2710/244; B60W 2520/10

(57) ABSTRACT

An apparatus for controlling mild hybrid electric vehicle may include: an engine; a mild hybrid starter and generator (MHSG) starting the engine or generating power by an output of the engine; a data receiving device receiving at least vehicle speed data, vehicle location data and traffic information; and a controller configured to control a state of charge (SOC) criteria for idle stop restriction based on the data supplied from the data receiving device.

### CROSS-REFERENCE TO RELATED APPLICATION

The present application claims priority to Korean Patent Application No. 10-2017-0177244 filed on Dec. 21, 2017, the entire contents of which is incorporated herein for all purposes by this reference.

### BACKGROUND OF THE INVENTION

### Field of the Invention

The present invention relates to an apparatus and method for controlling mild hybrid electric vehicle, and more particularly, to an apparatus for controlling mild hybrid electric vehicle controlling an idle stop entry condition according to driving conditions and a method thereof.

### Description of Related Art

As is generally known in the art, a hybrid electric vehicle utilizes an internal combustion engine and a battery power source together. The hybrid electric vehicle efficiently combines a torque of the internal combustion engine and a torque of a motor.

Hybrid electric vehicles may be divided into a hard type and a mild type according to power sharing ratio between an engine and a motor. In the case of the mild type of hybrid electric vehicle (hereinafter referred to as a mild hybrid electric vehicle), a mild hybrid starter & generator (MHSG) configured to start the engine or generate electricity according to an output of the engine is used instead of an alternator. In the case of the hard type of hybrid electric vehicle, a driving motor configured for generating driving torque is used in addition to an integrated starter & generator (ISG) configured to start the engine or generate electricity.

The MHSG may assist torque of the engine according to running states of the vehicle and may charge a battery (e.g., 48 V battery) through regenerative braking. Accordingly, fuel efficiency of the mild hybrid electric vehicle may be improved.

The mild hybrid electric vehicle provides idle stop mode to prevent unnecessary idling and fuel consumption when the engine power is not used.

However, there is a problem that, if the frequency of entering idle stop mode is high, durability of the battery may decrease rapidly and the driver may experience discomfort. when the vehicle enters the idle stop mode frequently when the vehicle is in a dangerous section, the risk of an accident because of not immediate engine start may increase

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing an apparatus and method for controlling mild hybrid electric vehicle which may decrease the risk of the accident and increase the durability of the battery by reducing the frequency of entering the idle stop in the dangerous section.

An apparatus configured for controlling mild hybrid electric vehicle according to an exemplary embodiment of the present invention may include: an engine; a mild hybrid starter and generator (MHSG) starting the engine or generating power by an output of the engine; a data receiving device receiving at least vehicle speed data, vehicle location data and traffic information; and a controller configured to control an SOC criteria for idle stop restriction based on the data supplied from the data receiving device.

When the vehicle speed is less than a predetermined speed, the controller may determine whether the vehicle is in a dangerous section, and when the vehicle is determined to be in the dangerous section, the controller may increase an SOC criteria for idle stop restriction from a default SOC value to an increased SOC value.

When the vehicle speed is equal to or greater than the predetermined speed, the controller may maintain the SOC criteria for idle stop restriction at the default SOC value.

When the vehicle is determined to be out of the dangerous section, the controller may decrease the SOC criteria for idle stop restriction from the increased SOC value to the default SOC value.

When the vehicle is determined to be still in the dangerous section, the controller may maintain the SOC criteria for idle stop restriction at the increased SOC value.

The traffic information may include navigation information, and the controller may determine the vehicle to be in the dangerous section when the vehicle is at least on an intersection, a railway, or an accident prone area.

A method for controlling mild hybrid electric vehicle according to an exemplary embodiment of the present invention may include: determining whether a speed of the vehicle less than a predetermined speed; when the vehicle speed is less than the predetermined speed, determining whether the vehicle is in a dangerous section based on a vehicle location information and a traffic information; and when the vehicle is determined to be in the dangerous section, increasing an SOC criteria for idle stop restriction from a default SOC value to an increased SOC value.

The method may further include; when the vehicle speed is equal to or greater than the predetermined speed, maintaining the SOC criteria for idle stop restriction at the default SOC value.

The method may further include; when the vehicle is determined to be out of the dangerous section, decreasing the SOC criteria for idle stop restriction from the increased SOC value to the default SOC value.

The method may further include; when the vehicle is determined to be still in the dangerous section, maintaining the SOC criteria for idle stop restriction at the increased SOC value. The traffic information may include navigation information, and in the step determining whether the vehicle is in the dangerous section, the vehicle may be determined to be in the dangerous section when the vehicle is at least on an intersection, a railway, or an accident prone area.

Various aspects of the present invention are directed to providing an apparatus and method for controlling mild hybrid electric vehicle which may decrease the risk of the accident and increase the durability of the battery by reducing the frequency of entering the idle stop in the dangerous section.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a block diagram of a mild hybrid electric vehicle according to an exemplary embodiment of the present invention.

FIG. 2 is a diagram illustrating a portion of an apparatus configured for controlling mild hybrid electric vehicle according to an exemplary embodiment of the present invention.

FIG. 3 is a flowchart illustrating a method for controlling mild hybrid electric vehicle according to an exemplary embodiment of the present invention.

It may be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the other hand, the invention(s) is/are intended to cover not only the exemplary embodiments, but also various alternatives, modifications, equivalents and other embodiments, which may be included within the spirit and scope of the invention as defined by the appended claims.

In the following detailed description, various exemplary embodiments of the present application will be described more fully with reference to the accompanying drawings, in which exemplary embodiments of the invention are shown. However, the present invention is not limited the exemplary embodiments which are described herein, and may be modified in various different ways.

Parts which are not related with the description are omitted for clearly describing the exemplary embodiment of the present invention, and like reference numerals refer to like or similar elements throughout the specification.

Since each component in the drawings is arbitrarily illustrated for easy description, the present invention is not particularly limited to the components illustrated in the drawings.

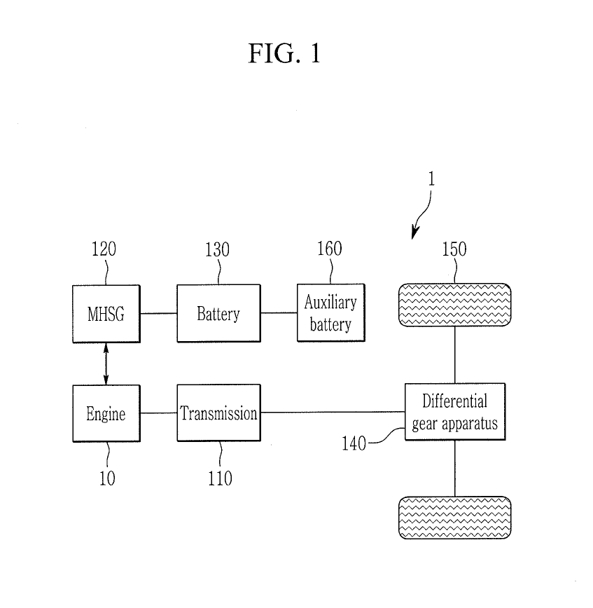

FIG. 1 is a block diagram of a mild hybrid electric vehicle according to an exemplary embodiment of the present invention.

As shown in FIG. 1, a mild hybrid electric vehicle 1 according to an exemplary embodiment of the present invention includes an engine 10, a transmission 110, a mild hybrid starter & generator (MHSG) 120, a battery 130, a differential gear apparatus 140, a wheel 150 and an auxiliary battery 160.

In connection with torque transmission of the mild hybrid electric vehicle 1, torque generated from the engine 10 is transmitted to an input shaft of the transmission 110, and a torque output from an output shaft of the transmission 110 is transmitted to an axle via the differential gear apparatus 140. The axle rotates the wheel 150 so that the mild hybrid electric vehicle runs by the torque generated from the engine 10.

The MHSG 120 starts the engine 10 or generates electricity according to an output of the engine 10. Furthermore, the MHSG 120 may assist the torque of the engine 10. In other words, the torque of the engine 10 may be used as main torque, and a torque of the MHSG 120 may be used as auxiliary torque. The MHSG 120 may be an inverter-integrated MHSG.

The battery 130 may supply electricity to the MHSG 120, and may be charged through electricity recovered by the MHSG 120 in a regenerative braking mode. The battery 130 may have 48 V voltage. The battery 130 may be a LDC-integrated battery including a LDC (low voltage DC-DC converter) which converts a voltage supplied form the battery 130 into a low voltage. The mild hybrid electric vehicle 1 may further include an auxiliary battery 160 charged with the low voltage converted by the LDC, and configured to supply low voltage (e.g., 12V) power to electronic loads of the mild hybrid electric vehicle 1.

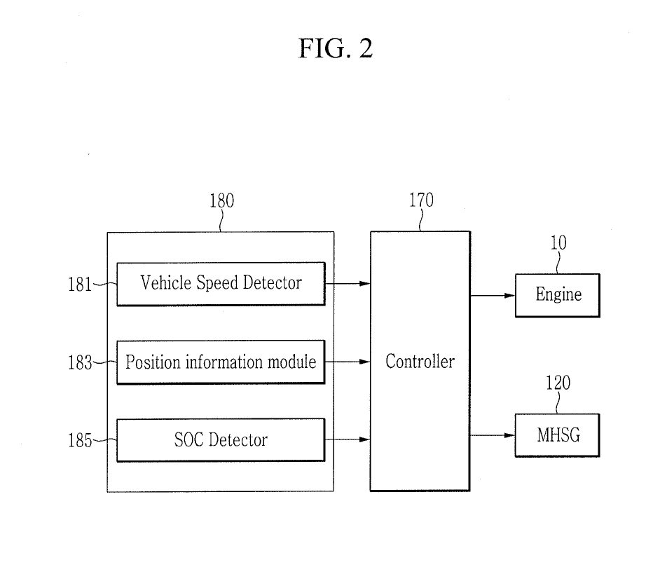

FIG. 2 is a diagram illustrating a portion of an apparatus configured for controlling mild hybrid electric vehicle according to an exemplary embodiment of the present invention.

As shown in FIG. 2, the apparatus controlling mild hybrid electric vehicle according to an exemplary embodiment of the present invention may further include a controller 170 and a data receiving device 180.

The controller 170 may control the idle stop operation of the vehicle 1 based on the data like vehicle speed information and vehicle location information supplied from the data receiving device 180.

The data receiving device 180 may receive the data necessary for controlling the idle stop operation and supply it to the controller 170. The data receiving device may include a vehicle speed detector 181, location information module 183 and SOC detector 185. The data receiving device 180 may further include detectors or devices receiving data necessary for controlling the mild hybrid electric vehicle (e.g., engine speed detector, acceleration detector).

The vehicle speed detector 181 may detect the speed of the vehicle 1 and generate vehicle speed data. The controller 170 may get the vehicle speed data necessary for controlling the idle stop operation through the vehicle speed detector 181.

The location information module 183 may receive at least location information related to the vehicle 1 and traffic information. The location information related to the vehicle 1 may be Global Positioning System (GPS) information. The traffic information may be navigation information or other location-based information supplied from a traffic information service provider, and may include information related to a dangerous section such as intersection, railway or accident prone area. The controller 170 may get the vehicle location information and the traffic information necessary for controlling the idle stop operation through the location information module 183.

The SOC detector 185 may detect a state of charge (SOC) value of the battery 130 and generate an SOC data. The controller 170 may get the SOC data necessary for controlling the idle stop operation through the SOC detector 185.

The controller 170 may get the SOC data necessary for controlling the idle stop operation through the SOC detector 185. When the SOC value of the battery 130 detected by the SOC detector 185 is less than the SOC criteria for idle stop restriction, the controller may restrict the vehicle from entering idle stop.

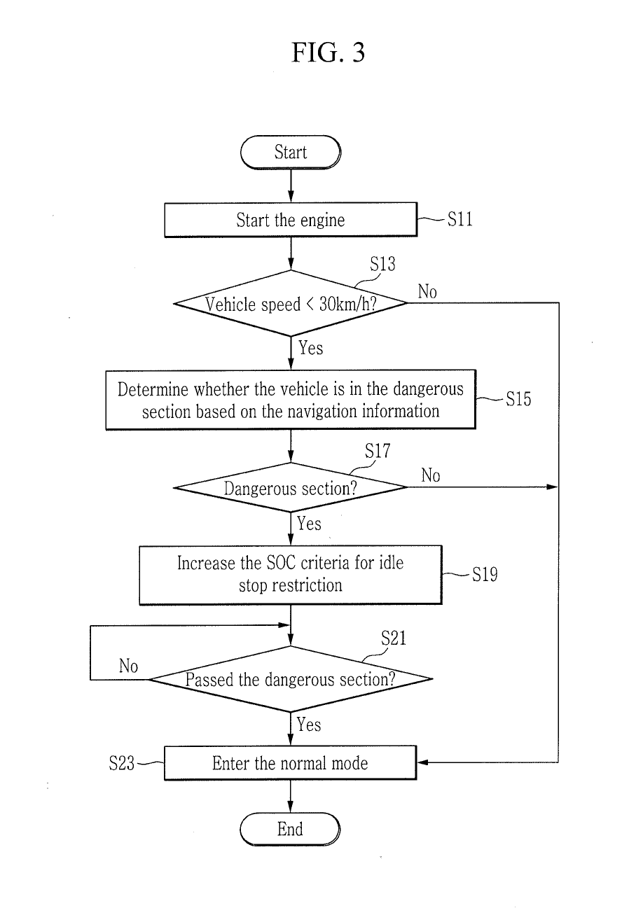

Hereinafter, a method for controlling mild hybrid electric vehicle according to an exemplary embodiment of the present invention will be described with reference to FIG. 3.

FIG. 3 is a flowchart illustrating the method for controlling mild hybrid electric vehicle according to an exemplary embodiment of the present invention.

As shown in FIG. 3, when the engine starts at step S11, the controller 170 determines whether the vehicle speed is less than a predetermined speed at step S13. The predetermined speed may be set to a value determined by a person of ordinary skill in the art to be suitable for the idle stop operation control. For example, the predetermined speed may be 30 kph.

When the vehicle speed is equal to or greater than the predetermined speed at step S13, the controller 170 enters a normal mode in which the SOC criteria for idle stop restriction is set as a default SOC value at step S23. The default SOC value may be set to a value determined by a person of ordinary skill in the art to be enough for the reliable engine start-up after idle stop in general situation. For example, the default SOC value may be 50% of the maximum SOC value of the battery 130.

When the vehicle speed is less than the predetermined speed at step S13, the controller 170 determines whether the vehicle 1 is in a dangerous section based on vehicle location information and traffic information at step S15. The controller 170 may determine that the vehicle 1 is in the dangerous section when the vehicle is located on intersections, railways, or accident prone area.

In an exemplary embodiment of the present invention, the accident prone area may be an area in which the vehicle accident occurs more than an average value, e.g., 50% of vehicle accident in a country or a town.

The dangerous section may further include other places in which a person of ordinary skill in the art determines that a vehicle may be easily exposed to a dangerous situation.

When the controller 170 determines that the vehicle 1 is not in the dangerous section at step S17, the controller 170 enters the normal mode at step S23.

When the controller 170 determines that the vehicle 1 is in the dangerous section at step S17, the controller 170 increases the SOC criteria for idle stop restriction from the default SOC value to the increased SOC value at step S19. The increased SOC value may be set to a value determined by a person of ordinary skill in the art to be enough for the reliable engine start-up after idle stop when the vehicle is in the dangerous section. For example, the increased SOC value may be 90% of the maximum SOC value of the battery 130.

The frequency with which the vehicle 1 enters idle stop may be reduced if the controller 170 increases the SOC criteria for idle stop restriction when the vehicle 1 in the dangerous section. This may reduce the risk of the vehicle becoming difficult to timely avoid dangerous situations due to the time it takes to start the engine 10 again.

Furthermore, even if the vehicle 1 enters idle stop in the dangerous section, it is made to have high enough SOC value of the battery 130 to ensure more reliable and quick engine start-up. Accordingly, startability of the engine may be improved and the safety of the mild hybrid electric vehicle 1 may be ensured when the vehicle 1 is in the dangerous section.

On the other hand, durability of the battery 130 may be improved because of the decreased frequency of unnecessary idle stop entry.

The controller 170 determines whether the vehicle 1 passed and got out of the dangerous section at step S21.

When the controller 170 determines that vehicle 1 is still in the dangerous section at step S21, the controller 170 maintains the SOC criteria for idle stop restriction at the increased SOC value.

When the controller determines that vehicle 1 passed the dangerous section at step S21, the controller 170 enters normal mode at step S23. In other words, the controller 170 decreases the SOC criteria for idle stop restriction from the increased SOC value to the default SOC value.

For convenience in explanation and accurate definition in the appended claims, the terms “upper”, “lower”, “inner”, “outer”, “up”, “down”, “upper”, “lower”, “upwards”, “downwards”, “front”, “rear”, “back”, “inside”, “outside”, “inwardly”, “outwardly”, “internal”, “external”, “inner”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An apparatus for controlling a vehicle, the apparatus comprising:
an engine;
a battery;
a mild hybrid starter and generator (MHSG) coupled to the engine and starting the engine or generating power by an output of the engine;
a data receiving device receiving data of at least one of a vehicle speed, a vehicle location and traffic information; and
a controller connected to the engine, the battery, the MHSG, and the data receiving device and configured to control a state of charge (SOC) criteria of the battery set for an idle stop restriction of the engine, based on the data supplied from the data receiving device;
wherein, when the vehicle speed is less than a predetermined speed, the controller is configured to determine whether the vehicle is in a predetermined location, and
when the vehicle is determined by the controller to be in the predetermined location, the controller is configured to increase the SOC criteria set for the idle stop restriction of the engine from a default SOC value to a predetermined SOC value.

2. The apparatus of claim 1, wherein, when the vehicle speed is determined, by the controller, to be equal to or greater than the predetermined speed, the controller is configured to maintain the SOC criteria for the idle stop restriction at the default SOC value.

3. The apparatus of claim 1, wherein, when the vehicle is determined, by the controller, to be beyond the predetermined location, the controller is configured to decrease the SOC criteria for the idle stop restriction from the predetermined SOC value to the default SOC value.

4. The apparatus of claim 1, wherein, while the vehicle is determined by the controller to be in the predetermined location, the controller is configured to maintain the SOC criteria for idle stop restriction at the predetermined SOC value.

5. The apparatus of claim 4, wherein, when the vehicle is determined by the controller, to be beyond the predetermined location, the controller is configured to decrease the SOC criteria for the idle stop restriction from the predetermined SOC value to the default SOC value.

6. The apparatus of claim 1,
wherein the traffic information includes navigation information, and
wherein the controller is configured to determine the vehicle to be in the predetermined location when the vehicle is at least on an intersection, a railway, or an accident prone area.

7. A method for controlling a mild hybrid electric vehicle, the method comprising:
determining, by a controller, whether a speed of the vehicle including an engine is less than a predetermined speed;
when the speed of the vehicle is less than the predetermined speed, determining, by the controller, whether the vehicle is in a predetermined location based on a vehicle location information and a traffic information; and
when the vehicle is determined, by the controller, to be in the predetermined location, increasing, by the controller, a state of charge (SOC) criteria of a battery in the vehicle for idle stop restriction of the engine, from a default SOC value of the battery to a predetermined SOC value.

8. The method of claim 7, further including:
when the speed of the vehicle is determined, by the controller, to be equal to or greater than the predetermined speed, maintaining, by the controller, the SOC criteria for the idle stop restriction at the default SOC value.

9. The method of claim 7, further including:
when the vehicle is determined, by the controller, to be beyond the predetermined location, decreasing, by the controller, the SOC criteria for the idle stop restriction, from the predetermined SOC value to the default SOC value.

10. The method of claim 7, further including:
while the vehicle is determined, by the controller, to be in the predetermined location, maintaining, by the controller, the SOC criteria for the idle stop restriction at the predetermined SOC value.

11. The method of claim 7,
wherein the traffic information includes navigation information, and
wherein, in the determining of whether the vehicle is in the predetermined location, the vehicle is determined, by the controller, to be in the predetermined location when the vehicle is at least on an intersection, a railway, or an accident prone area.
